(19) United States
(12) Patent Application Publication
(10) Pub. No.: US 2010/0205276 A1
(43) Pub. Date: Aug. 12, 2010

(54) SYSTEM AND METHOD FOR EXPLOITING A MEDIA OBJECT BY A FRUITION DEVICE

(76) Inventor: Giuseppe Stefano Quintarelli, Milano (IT)

Correspondence Address: DYKAS, SHAVER & NIPPER, LLP, P.O. BOX 877, BOISE, ID, 83701-0877, US

(21) Appl. No.: 12/671,739

(22) PCT Filed: Aug. 1, 2008
(86) PCT No.: PCT/IB2008/002004

§ 371 Date: Apr. 8, 2010

(30) Foreign Application Priority Data
Aug. 2, 2007 (IT) TO2007A000579

(51) Int. Cl. G06F 17/30; G06F 15/16; G06F 3/048

(52) U.S. Cl. 709/217; 707/802; 715/764; 707/E17.044

(57) ABSTRACT

The invention relates to a system and a method for exploiting a media object by a user's fruition device (3), said system comprising: a central computer (5); a fruition device (3) comprising connection means for connecting to said central computer (5) through a telecommunication network (9), in particular the Internet; a database (7), associated with said central computer (5), for storing and/or manipulating a notification relating to a media object, said notification being supplied to said database (7) through said fruition device (3) and allowing said media object to be retrieved on the Internet, said fruition device (3) comprising a graphic user interface adapted to allow said user to exploit said media object and/or to manipulate the notification thereof.

The present invention falls within the scope of information processing systems; more in particular, it relates to a system and a method for exploiting a media object by means of a fruition device.

Until the early '90s, there had been essentially no competition against the traditional television model, wherein audiovisual contents broadcast via cable, satellite or radio by a radio-television service, or “broadcaster”, is received by a user's television apparatus, possibly through a set-top box.

With the advent of the Internet and of digital processing devices equipped with increasingly complex functionalities, new fruition forms have appeared for exploiting audiovisual contents, more in general media objects.

In this frame, a “media object” is meant to be digital content consisting of audio and/or diagrams and/or fixed images and/or moving images. Some examples of media objects are movies, films, videoclips, animations, synchronised text and audio, synchronised images and audio, musical clips and tracks.

New media object fruition models have thus been added to the traditional television model, among which, for example, Web TV, IPTV, videogame consoles and mobile telephones.

For example, a possible way of exploiting a media object is offered by Web TV, which allows media objects to be exploited on a fruition device, e.g. a personal computer, a personal digital assistant, a laptop, and so on, said media objects being made available on Internet sites, in particular on sites like “YouTube”, radio-television service sites, portals and blogs, where there are large quantities of media objects. Said media objects can be used by a user either via streaming or by downloading the objects to his/her own fruition device for later use.

A further possible way of exploiting a media object is offered by IPTV, which allows a user to exploit media objects, in particular television contents, broadcast by a telephone company over a telephone line. The received television signal is processed by a set-top box and sent to a television set for the fruition of the corresponding content. IPTV is characterised in that all media objects available to the user, whether generated by a radio-television service or by Internet sites, are prearranged by the telephone company. This is a “walled garden” type model, wherein the user is obliged to use that company's services and is discouraged from using services provided by other companies.

A further way of exploiting a media object is provided by advanced videogame consoles, wherein the console is enabled for remote connection to a server owned by the console manufacturer in order to allow a user to use services provided by said manufacturer, e.g. downloading new videogames, interacting with other users when using “multiplayer” games, or using media objects made available by said manufacturer. However, the user of such consoles cannot use services or objects provided by manufacturers other than the one that manufactured the console in use.

A further way of exploiting a media object is provided by mobile telephones, which can receive digital television signals transmitted according to the DVB-H standard and play the associated contents on their own display. Currently the service for receiving a television signal on a mobile telephone is managed by telephone companies, which acquire the media objects to be transmitted, in particular television programs, from radio-television services. The latest generation mobile telephones are equipped with means for connecting to the Internet, e.g. through a telephone network or a wireless network. Thus, a mobile telephone can also be used for playing media objects published on Internet sites and visible in streaming mode.

The concrete possibility offered by mobile telephones of not necessarily constraining the user to services provided by a single company seems to be leading to a future where “walled garden” models like those mentioned above will unlikely survive. In fact, some videogame console manufacturers are already beginning to sell consoles which allow the user to navigate the Internet freely in order to import available media objects from it, thus de facto releasing the user from the constraint of having to use that manufacturer's services only.

The actual possibility of fruition is nevertheless strongly limited by incompatibility between media objects and fruition devices. Such incompatibility mainly concerns codings (codecs), resolutions, bit-rates and user interfaces.

These new media object fruition types also very much question the traditional television model, based on analog or digital pay television (“pay-tv”).

As known, in fact, the traditional television model is financed through incomes deriving from advertisements placed between and within broadcast programs. The new media object fruition forms have taken a part of the audience away from traditional television, who have begun to use media objects in a different manner. Consequently, an adverse process has started for radio-television services, since less audience leads to a lower economical value of advertisements and thus to a lower income for the broadcasting company.

Being well aware of the existence of new ways of exploiting media objects through the Internet, advertising agencies have devised new television advertising forms like, for example, indirect advertising (“product placement”) or superimposed advertisements, conceived in order to outwit the functionalities of new digital video recorders that, thanks to a “timeshifting” function, allow the user to “skip” any advertisements in a program and resume the recording after the advertisement has, ended, and advertising within programs. However, these new advertising forms are disliked by the spectator, who does not want to be disturbed by advertisements even when he/she is watching a program.

On the Internet front as well, advertising agencies have adapted themselves to the new ways of placing advertisements in media objects, e.g. by advertising through banners placed on pages of Internet sites and at the beginning or end of a video. However, all these types of advertising are easily avoidable by a user, in the former case by simply ignoring it, and in the latter case by acting appropriately on the controls of the players, typically software ones, used for playing the videos.

In this new kind of scenario, two new requirements arise: for the audience, the need to use large quantities of media objects on the Internet with the utmost freedom of fruition; for advertising agencies, the need to find new ways of placing advertisements in media objects available on the net.

Yet, no systems or methods currently exist which can bring together these two kinds of needs.

The main object of the present invention is therefore to provide a method and a system for exploiting a media object available on the Internet by means of any fixed or mobile fruition device.

It is a further object of the present invention to provide a method and a system for exploiting a media object by a fruition device which allow a user to create his/her own program schedule based on media objects available on the Internet.

It is a further object of the present invention to provide a method and a system for exploiting a media object by a fruition device which offer the user the possibility of sharing his/her own experience, program schedule or media objects with his/her social network.

It is a further object of the present invention to provide a method and a system for exploiting a media object by a fruition device which allow advertising agencies to place advertisements.

These and other objects of the invention are achieved by the method and the system as claimed in the appended claims, which are intended as an integral part of the present description.

In short, the method according to the present invention can be divided into three implementation stages.

During a first stage of the method according to the invention, a user profile is created, i.e. the user registers him/herself into a central computer of a system according to the invention through a fruition device, thereby supplying information including, in particular, the types of fruition devices available to him/her, e.g. television sets, set-top boxes, mobile telephones, personal digital assistants, personal computer with a monitor and so on, and a list of people belonging to his/her social network.

The user profile may also be handled automatically through automatic detection of the user's fruition devices at login time, once the user's data has been verified.

During a second stage, the user manages and manipulates a plurality of media object notifications and/or actual media objects, still by using a fruition device, so that he/she can exploit them later on a fruition device of his/her own, and makes said plurality of notifications available to his/her own family community and/or friend community.

During a third stage, the user connects to the central computer of the system according to the invention through a fruition device, the existence of which being already known to the system because the user provided information about it during the first profile creation stage, or its characteristics being identified by the system as the user's device logs in.

The fruition device comprises means for connecting to the central computer and a simplified graphic interface optimised for that specific fruition device, through which the user can enjoy the media object, and which has technical parameters suitably adapted to that device, in addition to having a set of functions such as storing a notification and/or a media object, and deleting or inhibiting certain users from exploiting a media object.

Since the fruition device and its characteristics, in particular the characteristics of its screen and its screen format, are known to the system because they were entered by the user during the profile creation stage or because they were detected by the system as fruition began, the system can also convert and/or provide the media object into the most appropriate format for the fruition device in use.

The above objects will become more apparent from the detailed description of the method and system according to the invention, with particular reference to the annexed figures, wherein:

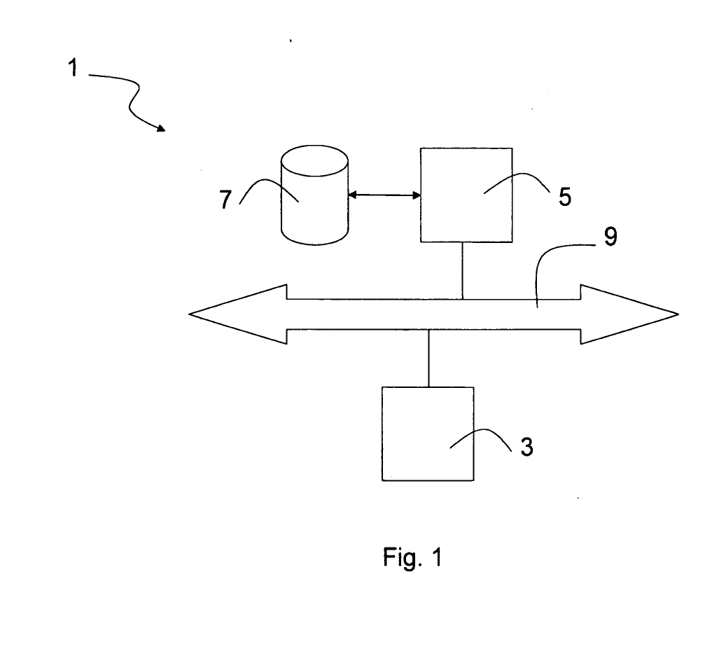

FIG. 1 is a block diagram of a system according to the invention for exploiting a media object by a fruition device;

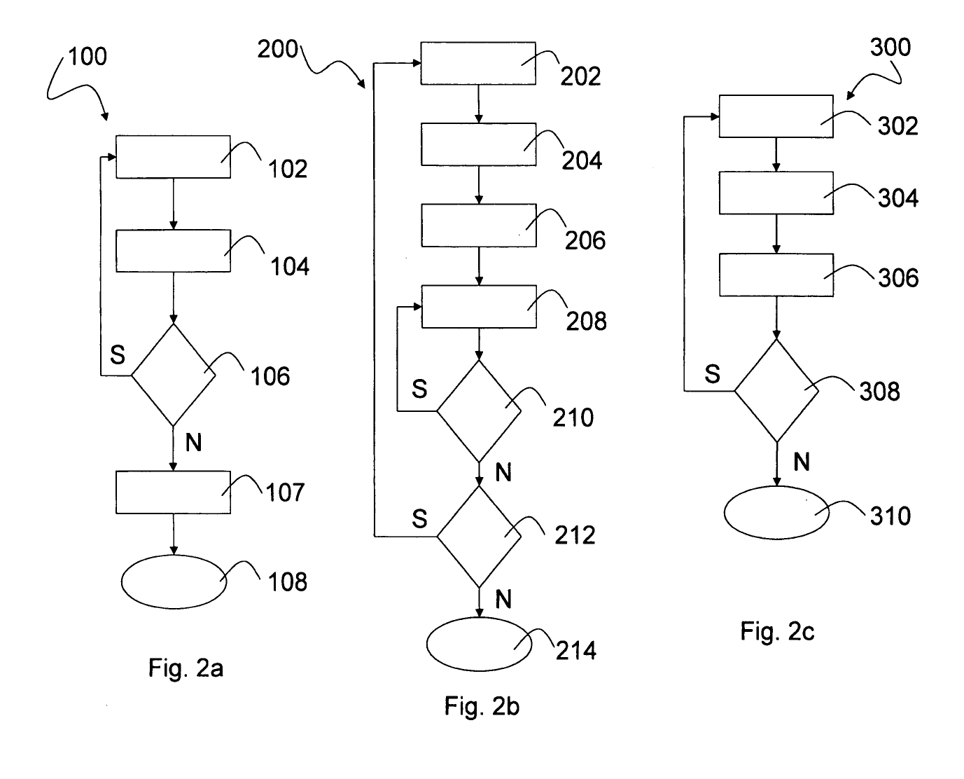

FIGS. 2a, 2b and 2c respectively show a first, a second and a third stages of a method according to the invention for exploiting a media object by a fruition device.

Referring now to FIG. 1, there is shown a system 1 for exploiting a media object by a fruition device 3, comprising at least one central computer 5, or server, associated with at least one database 7.

The central computer 5 is equipped with means for accessing the Internet through a communication network 9.

The fruition device 3 may be any device capable of supporting a graphic user interface; for example, it may be a television set, a personal digital assistant, a mobile telephone, a set-top box, a laptop, a personal computer with a monitor, a videogame console, a portable multimedia reader, and so on.

The central computer 5 is set up for managing a plurality of users of the system 1 who have access, by means of a respective fruition device 3, to said central computer 5, typically through an Internet site, after having logged in by entering a user name and a password or other types of personal data, e.g. the identifier of an access line or a telephone SIM (“Subscriber Identity Module”), or any other logical or physical parameter that identifies the user univocally.

The method according to the invention starts with a profile creation stage 100, wherein the user enters, through a fruition device 3, all the types of fruition devices 3 available to him/her and the characteristic display parameters of said fruition devices 3.

The initial profile creation stage is carried out when the user registers for the first time into the service managed by the system 1, or when the user wants to change, remove or add fruition devices 3 and/or their characteristic display parameters, or when the user logs in with a new device, or as fruition begins.

With reference to FIG. 2, a procedure 100 of the initial profile creation stage comprises a step 102, wherein the system automatically recognises, or the user manually enters, the type of fruition device 3 available to him/her, and a step 104, wherein the user specifies, or the system establishes through automatic recognition, the characteristic display parameters of the fruition device 3.

At step 106, the procedure implemented in the central computer 5 waits for the user to subject other fruition devices 3 to automatic recognition or asks the user of the system 1 if he/she wishes to add other fruition devices 3 to his/her own profile: if yes, the procedure will go back to step 102; if not, the procedure will go on to step 108, where it will stop.

The procedure 100 can be exemplified by assuming than the user owns, as fruition devices 3, a set-top box, a mobile telephone, a videogame console, and a personal computer with a monitor. For each of these fruition devices 3, he/she will enter one or more characteristic display parameters, e.g. resolution and/or format of the fruition screen associated with the device. For example, the user may specify that the set-top box can support both the 4:3 and the 16:9 formats, and that the personal computer can support the various possible resolutions of the associated monitor, e.g. 1400×1050, 1280×1024, 1280×768, 1024×768, and so on.

Such characteristic display parameters may also be determined dynamically or by consulting configuration databases relating to fruition devices 3.

At step 107 of the profile creation procedure 100, the user can set up a social network of his/her own comprising, for example, names of people known to the user and associated personal data, like instant messaging addresses, electronic mail addresses, telephone numbers, social networking service data, etc.

The user's social network comprises at least two different media object sharing profiles, in particular a sharing profile of the “Family” type and a sharing profile of the “Friends” type, as well as a profile of the “Private” type.

Media objects classified with a “Friends” type sharing profile can be shared freely with any users belonging to the “Friends” sharing profile.

However, the user may decide that some media objects, in particular those belonging to the user's most intimate sphere, cannot be shared with some people, who will thus be classified in the “Family” sharing profile.

Using a “Family” sharing profile advantageously allows to control the contents of the media objects which can be viewed by a person belonging to a family. For example, a parent can filter beforehand the media objects which another family member, e.g. a child, is allowed to watch, and then place the allowed media objects into a media object container dedicated to that family member.

The user may also decide to not share a media object with any member of his/her community and to enter it into his/her own “Private” profile.

The procedure 100 ends at step 108.

Once the user profile has been created, the method according to the invention carries out a second notification management and manipulation stage 200, wherein the user can perform a series of operations for notifying media objects to one or more users belonging to his/her own social network.

Notifications are managed and manipulated by connecting a user's fruition device 3 to the central computer 5 (step 202) through the communication network 9, in particular the Internet.

Notification management is carried out at step 204; notifications may take place as follows:
in “push” or “pull” type automatic mode, e.g. by portals, sites, blogs, radio-television services, based on keywords, metadata, tags or evaluation indexes used by sites like “Digg” and “Stumbleupon”;
in “embedded” mode, wherein the notification relating to a media object available on the Internet consists of a direct link to the media object itself, so that it is not necessary to search for the media object by visiting the hosting site or portal;
in “reference” mode, wherein the link to the media object is sent through an electronic mail message or an instant messaging service;
in “connection” mode, wherein the link comes directly from the connection bar of an Internet site;
in “push” mode, wherein the user asks the system to verify and indicate the availability of new media objects related to the appearance, for example, of new videos on a site, new videos with a certain tag, new videos from a certain source or by a certain author;
in “toolbar” mode, wherein the user simply presses an icon, a push-button or the like displayed on the screen, preferably within a toolbar; by pressing the icon, a software which installed the icon will analyse the contents of the Web page currently displayed by the user, providing a list of all video sequences found on that page; the user may select one or more video sequences of interest and send a related notification to the central computer 5.

The notification may also be made accessible to a group of users, e.g. determined on the basis of predetermined themes corresponding to a common passion or interest, e.g. chess, football, photography, politics, etc.

At step 206, one of the notifications managed at step 204 is selected. At step 208, one of the possible operations on notifications is carried out. Such operations include:
storing a notification into the database 7, possibly by integrating it with additional data, e.g. metadata, tags and ranking: a notification may be stored in a manner such that it is accessible to both the users registered under the “Friends” sharing profile and the users registered under the “Family” sharing profile, or only to the users registered under the “Family” sharing profile or, if the user decided not to share it, it may be entered into the “Private” profile or among the user's contacts;
storing a media object into a storage device external to the system: this happens when the object addressed by the notification resides in a memory of a user's computer which is not accessible from the outside, so that a simple saving operation would not allow the user to access the object: in this case, the media object will only be shared with the users registered under the “Family” sharing profile;
storing the media object into a cache memory with additional data such as bookmark, hierarchy, metadata and ranking increment;
sending the notification to both the user's social network and the site users' community, possibly also entering a message; messages, which may even contain videos, can be sent to other users, whether attached to a notification or to a media object;
assigning a vote to the media object, e.g. by incrementing an associated counter if the user wishes to recommend that media object to the other users belonging to his/her social network, or by decrementing said counter if the user wishes not to recommend that media object: the counter thus allows to create a place-list of the contents that have been appreciated most and least by the user;
deleting media objects or inhibiting media objects, meaning that they may be used by the user only or by a determined list of other users.

Media objects may possibly be taken from a media object source, said source being external to the system 1.

At step 210, the system asks the user if there are any other operations to be managed in relation to the notification selected at step 206, awaiting further actions; if yes, the procedure will go back to step 208: otherwise, it asks if there are any other notifications to be handled (step 212); if there are, or if the wait time expires, the procedure will go back to step 202; otherwise, the procedure 200 will end (step 214).

The system 1 compiles and sends to the user by electronic mail a selection of summaries, or “digest”, which contains:
the variations occurred in the user's social network, e.g. added users, users invited to use the system 1, and so on,
the media objects which have been shared by the user's social network.

Instead of being sent by electronic mail, digests may be made available through RSS feeds, wherein each digest is an RSS feed.

The method according to the invention also comprises a third media object fruition stage 300, wherein the media objects managed and manipulated during the second procedure 200 of the method are usable anywhere by any fruition device 3.

The fruition device 3 may be any fixed or mobile device capable of supporting a simplified graphic interface and of connecting to the central computer 5 (step 302) through a communication network, e.g. via a satellite, cable, telephone (either fixed or mobile) or wireless connection, as well as of allowing a user to exploit a media object.

The graphic user interface is a simplified interface that comprises a limited number of icons or commands possibly organised according to a tree structure and associated with:
storage means for storing notifications relating to media objects and/or the media objects themselves into the database 7;
transmission means for sending notifications relating to media objects to other site users and/or to the user's social network;
sharing means for sharing notifications relating to media objects;
voting means for assigning votes to media objects;
deletion means for deleting notifications relating to media objects and/or the media objects themselves;
inhibition means for inhibiting notifications relating to media objects and/or the media objects themselves;
search means for searching for media objects available on the site, e.g. through keywords or metadata or tags;
insertion means, available to an advertising agency, for inserting and/or excluding advertising contents into/from said graphic user interface.

The user is typically presented a list of video and/or audio sequences, or “playlist”, stored in the database 7 and associated with him/her. Each playlist defines a “feed” or a “podcast”, which a fruition program can use and play or transfer to the local memory of a fruition device 3, by using a standard like RSS (Really Simple Syndication) or the like.

At step 304, the user is asked to select a command among the above, and at step 306 the operation associated with said command is carried out.

At step 308, the user is asked if he/she wants to select another command: if yes, the procedure will go back to step 302, otherwise it will stop (step 310).

The operations carried out by the fruition device 3 are implemented through a computer product containing software code portions that can be loaded into a memory of the fruition device 3.

The simplified graphic user interface can be implemented in newly designed fruition devices 3 as well as in existing ones. In the latter case, several types of fruition devices 3 can be identified:
“closed” type fruition devices 3, for which the graphic interface can be implemented in the fruition device 3 through suitable plug-ins developed by companies selling fruition devices 3 and/or offering content providing services;
fruition devices 3 compatible with media object fruition, for which the graphic interface can be implemented through suitable plug-ins developed by subjecting specific sources to “screen scraping” or through other techniques for determining the video contents available in non-specific sources, e.g. network traffic analysis;
fruition devices 3 not compatible with media object fruition, for which the media object is appropriately converted by the central computer 5 into a format supported by the fruition device and stored into an associated cache memory of the system 1 for subsequent use.

The conversion into a format different from the original one is carried out in accordance with the user profile based on the technical specifications of both the fruition device 3 and the telecommunication network 9, e.g. whether the fruition device 3 is a mobile or fixed one.

More in particular, the central computer 5 comprises means for converting the screen format and/or resolution of a media object into a second screen format and/or resolution on the basis of the characteristic display parameters and/or for converting the bit-rate in order to adapt it to the communication network 9, and/or for converting the user interface in order to adapt it to the display characteristics of the fruition device 3.

Through the graphic user interface of the fruition device 3, a known advertising agency with a profile stored in the system 1 can insert advertising contents. However, by paying a sum of money to the company that manages the system 1, the user can avoid receiving advertising contents.

Advertising contents may advantageously be aimed at users on the basis of specific interests selected by the user during the profile creation stage 100, and be sent, for example, to all users entered in the user's “Friends” profile and/or “Family” profile and/or in transversal groups interested in specific advertising contents.

Such sets of interested users may also be determined by analysing data taken from the users themselves, e.g. the names of the saved video files, the sources of said files, the “tags” possibly associated with said files, file authors or musical tracks, or other data available in the system and associated with user profiles (group lists, hobbies, etc.)

The structure of the system 1 allows for the automatic creation of a program schedule, by placing in succession media objects, in particular videos, in which each user is interested, said media objects being determined by analysing the data of the user's personal profile and the contents saved by the user.

In addition or as an alternative, the program schedule may be created by using the media objects discovered and entered by the user and by his/her social network.

The programs of the program schedule may be played sequentially as an uninterrupted sequence of videos (“River of Videos”) which are specific for a single user or for a small group of users having similar interests.

The features of the present invention, as well as its advantages, are apparent from the above description.

The present invention allows to exploit any media object by means of a fruition device after having registered that device into the system according to the invention.

Another advantage of the present invention is that a user of the system according to the invention can create his/her own program schedule by retrieving various media objects notified by the user community of the system 1, by his/her family and/or friends, or automatically.

A further advantage of the present invention is that a user of the system according to the invention can share notifications of media objects available on the Internet or his/her own program schedules with the user community of the system 1, with his/her family or with his/her friends, and express his/her interest in or indifference to a certain media object.

Another advantage of the present invention is that an advertising agency can place advertisements specifically aimed at a system user through the graphic interface of the media object fruition device owned by that user.

A further advantage of the present invention is that the system can create a program schedule automatically, by placing in succession each user's videos of interest determined by analysing the data of the user's personal profile and the contents saved by the user: the tastes of the users and their social networks will determine the contents that will be exploited, without the need for a centralised program schedule defined by a broadcasting company.

A further advantage of the present invention is that contents are discovered and entered into the above-mentioned program schedules directly by the users and by their social networks without needing a centralised content acquisition function provided by a broadcasting company.

A further advantage of the present invention is that the programs of the program schedule can be played sequentially as an uninterrupted sequence of videos specific for a single user or a small group of users having similar interests, so that they are perceived as a normal flow television without however having the inelasticity of a program schedule common to a broad generality of users, which is typical of broadcast systems.

Another advantage of the present invention is that promotional videos relating to the users' preferred topics as well as informational and advertising promotional contents can be inserted into the program schedule played in “River of Videos” mode, thus providing a service to the producers of said contents and to those users who are interested therein.

The method and system for exploiting a media object by a user's fruition device described herein by way of example may be subject to many possible variations without departing from the novelty spirit of the inventive idea; it is also clear that in the practical implementation of the invention the illustrated details may have different shapes or be replaced with other technically equivalent elements.

For example, the system 1 has been described herein mainly in view of the fruition of media objects with audio and video contents.

However, the present invention may also be implemented for using the system and method according to the invention for media objects with audio contents only.

In this case, it will not be necessary to store information about the screen format of the fruition devices into the database.

For example, the system 1 may be signalled on various pages of Web sites in the same way as existing “social network” platforms, e.g. like “del.icio.us”.

For example, the system 1 may include contents generated and entered by the user, a client for torrent files, e.g. like Bittorrent, and be integrated with platforms for sharing videos and photographies, e.g. like Flickr (www.flickr.com).

For example, the system has been conceived as an open architecture offering anyone the possibility of expanding it through application programming interfaces, or APIs, and open protocols, thus becoming a platform with several additional functionalities created by users of the system, and binding the users to the system by exploiting a “lock-in” mechanism.

It can therefore be easily understood that the present invention is not limited to the above-described method and system for exploiting a media object by a user's fruition device, but may be subject to many modifications, improvements or replacements of equivalent parts and elements without departing from the novelty spirit of the inventive idea, as clearly specified in the following claims.

1. System for exploiting a media object by a user's fruition device (3), said system comprising:
a central computer (5);
a fruition device (3) comprising connection means for connecting to said central computer (5) through a telecommunication network (9), in particular the Internet;
a database (7), associated with said central computer (5), for storing and/or manipulating a notification relating to a media object, said notification being supplied to said database (7) through said fruition device (3) and allowing said media object to be retrieved on the Internet,
said fruition device (3) comprising a graphic user interface adapted to allow said user to exploit said media object and/or to manipulate the notification thereof.

2. System according to claim 1, characterised in that said notification relating to said media object is a link to an Internet site.

3. System according to claim 1, characterised in that said notification relating to said media object is contained in a message, in particular an electronic mail or instant messaging message.

4. System according to claim 1, characterised in that said notification relating to said media object is obtained from an Internet site through a “screen scraping” process or by means of a network traffic analysis.

5. System according to claim 1, characterised in that said notification relating to said media object is a notification based on keywords, metadata, tags or evaluation indexes used by sites, portals, blogs or radio-television services.

6. System according to claim 1, characterised in that said notification relating to said media object is related to the appearance of new videos on a site, new videos with a certain tag, new videos from a certain source or by a certain author.

7. System according to claim 1, characterised in that said communication network (9) is a satellite type one.

8. System according to claim 1, characterised in that said communication network (9) is a cable type one.

9. System according to claim 1, characterised in that said communication network (9) is a telephone type one, either fixed or mobile.

10. System according to claim 1, characterised in that said communication network (9) is a wireless type one.

11. System according to claim 1, characterised in that said graphic user interface of said fruition device (3) is a simplified graphic user interface comprising a limited number of functions.

12. System according to claim 1, characterised in that said graphic user interface of said fruition device (3) comprises storage means for storing said notification relating to said media object into said database (7).

13. System according to claim 1, characterised in that said graphic user interface of said fruition device (3) comprises storage means for storing said media object into said database (7).

14. System according to claim 1, characterised in that said graphic user interface of said fruition device (3) comprises storage means for storing data of a social network into said database (7).

15. System according to claim 1, characterised in that said graphic user interface of said fruition device (3) comprises transmission means for transmitting said notification relating to said media object and/or said media object.

16. System according to claim 1, characterised in that said graphic user interface of said fruition device (3) comprises sharing means for sharing said notification relating to said media object and/or said media object.

17. System according to claim 1, characterised in that said graphic user interface of said fruition device (3) comprises voting means for assigning a vote to said media object.

18. System according to claim 1, characterised in that said graphic user interface of said fruition device comprises deletion means for deleting said notification relating to said media object and/or said media object.

19. System according to claim 1, characterised in that said graphic user interface of said fruition device (3) comprises inhibition means for inhibiting said notification relating to said media object and/or said media object.

20. System according to claim 1, characterised in that said graphic user interface of said fruition device (3) comprises search means for searching for media objects, e.g. through keywords or metadata or tags.

21. System according to claim 1, characterised in that said central computer (5) comprises insertion means for inserting advertising contents into said graphic user interface.

22. System according to claim 21, characterised in that said central computer (5) comprises exclusion means for excluding advertising contents from said graphic user interface.

23. System according to claim 1, characterised in that characteristic display parameters of at least one fruition device (3) of said user are stored into said database (7) through said fruition device (3), so that said media object will be displayed on said fruition device (3) according to said characteristic display parameters of said fruition device.

24. System according to claim 23, characterised in that said characteristic display parameters comprise at least the resolution and/or format of a screen of said fruition device.

25. System according to claim 23 or 24, characterised in that said characteristic display parameters of said fruition device (3) are recognised automatically by said system.

26. System according to claim 25, characterised in that said media object is played in real time in accordance with said automatically recognised characteristic display parameters of said fruition device (3).

27. System according to claim 23, characterised in that said central computer (5) comprises means for converting the screen format and/or resolution of said media object into a second screen format and/or resolution on the basis of said characteristic display parameters and/or for converting the bit-rate in order to adapt it to the communication network (9), and/or for converting the user interface in order to adapt it to the display characteristics of said fruition device (3).

28. System according to claim 1, characterised in that said media object may be taken from a source of media objects, said source being external to said system.

29. System according to claim 1, characterised in that said fruition device (3) is a personal computer with a monitor.

30. System according to claim 1, characterised in that said fruition device (3) is a set-top box.

31. System according to claim 1, characterised in that said fruition device (3) is a television set.

32. System according to claim 1, characterised in that said fruition device (3) is a mobile telephone.

33. System according to claim 1, characterised in that said fruition device (3) is a personal digital assistant.

34. System according to claim 1, characterised in that said fruition device (3) is a videogame console.

35. System according to claim 1, characterised in that said fruition device (3) is a portable multimedia reader.

36. Method for exploiting a media object by a user's fruition device (3), said method comprising the following stages:
a) connecting a fruition device (3) to a central computer (5) through a communication network (9), in particular the Internet;
b) storing and/or manipulating a notification relating to a media object, said notification being stored into a database (7) associated with said central computer (5), through said fruition device (3), and allowing said media object to be retrieved on the Internet;
c) exploiting said media object and/or manipulating the notification thereof through said fruition device (3).

37. Method according to claim 36, characterised in that said fruition device (3) is provided with a simplified graphic interface comprising a limited number of functions for manipulating said at least one notification and/or said media object associated with said at least one notification.

38. Method according to claim 37, characterised in that said limited number of functions include:
storing said at least one notification and/or said media object associated with said at least one notification,
sending said at least one notification to other users,
sharing said at least one notification with other users,
assigning a vote to said media object associated with said at least one notification,
deleting said at least one notification and/or the associated media object,
inhibiting the media object associated with said at least one notification,
searching for a media object.

39. Method according to claim 36, characterised by comprising a step of inserting advertising contents into said media objects.

40. Method according to claim 39, characterised in that said advertising contents are based on the user profile and/or on data derived from the videos saved by the users, preferably file names, sources, tags, or other information associated or that can be associated with videos, preferably authors and musical tracks.

41. Method according to claim 39 or 40, characterised in that said advertising contents contain both information and advertisements.

42. Method according to claim 36, characterised in that said stage a) comprises a step of entering data about said user and about a social network of said user.

43. Method according to claim 42, characterised by compiling a selection of summaries, or “digests”, containing any variations occurred in the user's social network and the media objects which have been shared by the user's social network.

44. Method according to claim 43, characterised in that said digests are sent to a user by electronic mail.

45. Method according to claim 44, characterised in that said digests are made available to a user through an RSS feed, wherein each digest is an RSS feed.

46. Method according to claim 36, characterised in that said stage a) comprises a step of entering, or determining automatically or by consulting a database, the characteristic display parameters of said at least one fruition device (3).

47. Method according to claim 46, characterised in that said media object is converted into a screen format and/or resolution and/or bit-rate suitable for said at least one fruition device (3) on the basis of said characteristic display parameters, which can be obtained thanks to a user profile creation stage.

48. Method according to claim 42, characterised by creating automatically a program schedule for said user by placing in succession media objects, in particular videos, determined by analysing the data of the user's personal profile and of the media objects exploited by the user.

49. Method according to claim 48, characterised by creating a program schedule for said user by using media objects entered by the user and/or by said user's social network.

50. Method according to claim 48 or 49, characterised in that the programs of the program schedule are played sequentially as an uninterrupted sequence of videos specific for a single user or a small group of users having similar interests.

51. Method according to claim 36, characterised in that said notifications are received automatically or from other users.

52. Computer product comprising software code portions which can be loaded into a memory of a fruition device (3) in order to implement the method according to any of claims 36 to 51 in said device.
